(19) United States
(12) Patent Application Publication
(10) Pub. No.: US 2026/0040101 A1
(43) Pub. Date: Feb. 5, 2026

(54) REAL AND PREDICTED MEASUREMENT EVENT PRIORITIZATION

(71) Applicant: InterDigital Patent Holdings, Inc., Wilmington, DE (US)

(72) Inventors: Oumer Teyeb, Montreal (CA); Brian Martin, Farnham (GB); Dylan Watts, Montreal (CA); Yugeswar Deenoo Narayanan Thangaraj, Chalfont, PA (US); Shahab Hamidi-Rad, Sunnyvale, CA (US); Ahmed Mostafa, Ottawa (CA); Patrick Tooher, Montreal (CA)

(73) Assignee: InterDigital Patent Holdings, Inc., Wilmington, DE (US)

(21) Appl. No.: 18/794,695

(22) Filed: Aug. 5, 2024

(51) Int. Cl. H04W 24/08; H04W 24/10

(52) U.S. Cl. CPC H04W 24/08; H04W 24/10

(57) ABSTRACT

A WTRU may receive configuration information that includes a first measurement event, a second measurement event, a first action associated with the first measurement event, a second action associated with the second measurement event, criteria associated with the first measurement event, criteria associated with the second measurement event, and/or a condition. The WTRU may predict measurements based on the measurements that are determined based on the one or more reference signals. The WTRU may determine measurements. The WTRU may determine whether the first measurement event is fulfilled. The WTRU may determine whether the second measurement event is fulfilled. The WTRU may select the first action or the second action based on the condition, a determination of whether the first measurement event is fulfilled, and a determination of whether the second measurement event is fulfilled. The WTRU may perform the selected action.

### BACKGROUND

In NR, for example, when a WTRU is in radio resource control (RRC)_CONNECTED state, the WTRU may measure the signal level of one or more beams of a cell and/or the measurements results may be averaged to determine (e.g., derive) the cell quality. The WTRU may be configured to consider a subset of the detected beams. Filtering may take place at two different levels: at the physical layer (L1) level to derive beam quality and/or at RRC (L3) level to derive cell quality from one or more (e.g., multiple) beams. Cell quality from beam measurements may be derived in the same way for the serving cell(s) and/or for the non-serving cell(s). Measurement reports may include the measurement results of the X best beams, for example, if the WTRU is configured to do so by the gNB.

### SUMMARY

A wireless transmit/receive unit (WTRU) may prioritize a future predicted event over a current real triggered event, for example, even if one or more certain conditions are met. For example, if a first (e.g., real) measurement event is triggered for a first conditional reconfiguration, while a second (e.g., predicted) measurement event has been triggered (and/or reconfiguration pending) for a second conditional reconfiguration and/or a configured criteria is met, the WTRU may defer the first conditional reconfiguration and/or may wait for and/or execute the second conditional reconfiguration.

One or more other (e.g., new) events may be described herein which compare the outcome of predicted and real measurements and/or may trigger an action (e.g., a measurement report, execution of a conditional handover (CHO), etc.) based on the outcome. For example, the first measurement event (and/or report and/or conditional reconfiguration may be triggered if predicted measurement of cell x is less than a current measurement of cell Y (e.g., predicted measurement of cell x<current measurement of cell Y). Additionally or alternatively (e.g., to separate events for real and/or predicted, and/or defining the interaction condition), this may be realized by introducing one or more other (e.g., new) events which (e.g., only) trigger when a condition related to real measurements and/or a condition related to predicted measurements are met.

A WTRU may receive configuration information that includes one or more of a first measurement event, a second measurement event, a first action associated with the first measurement event, a second action associated with the second measurement event, criteria associated with the first measurement event, criteria associated with the second measurement event, and/or a condition. The WTRU may determine measurements based on one or more reference signals. The WTRU may predict one or more measurements based on the measurements that are determined based on the one or more reference signals. The WTRU may determine whether the first measurement event is fulfilled based on the measurements and/or the criteria associated with the first measurement event. The WTRU may determine whether the second measurement event is fulfilled based on i) the criteria associated with the second measurement event and ii) the measurements or predicted measurements that are based on the measurements. The WTRU may select the first action and/or the second action based on the condition, a determination of whether the first measurement event is fulfilled, and a determination of whether the second measurement event is fulfilled. The WTRU may perform the selected action.

Performing the selected action may include one or more of the following. Performing the selected action may include suspending, delaying, and/or canceling of a first conditional reconfiguration and/or reporting of a first measurement report. Performing the selected action may include triggering the first conditional reconfiguration and/or sending an indication to a first cell and/or a second cell. The indication may indicate that the second measurement event has been triggered. Performing the selected action may include modifying the criteria associated with the first and/or second measurement event. Performing the selected action may include sending a measurement report. Performing the selected action may include performing an early synchronization process. Performing the selected action may include performing a handover process.

The condition (e.g., associated with the action) may include one or more of a time to second reconfiguration execution is less than a threshold, a second reconfiguration is higher priority, a priority value, a reconfiguration type, a target type, a time of stay in a first target is below a threshold, whether the WTRU has a valid timing advance (TA) for one target or the other target, radio link failure probability of one or more targets, probability of success for a second reconfiguration is high, a pending data amount, a buffer size, one or more configured parameters at a potential target cell, prediction reliability, and/or a comparison of the first set of measurements and the one or more predicted measurements.

The WTRU may send a measurement report to a first cell. The measurement report may include an indication of a determined action and/or prioritization. The WTRU may update the configuration information, for example, based on one or more of the measurements and/or the predicted measurements. The WTRU may use artificial intelligence (AI) and/or machine learning (ML) to determine the predicted measurements.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of a NR measurement model.

FIG. 3 depicts an example scenario of two configured events.

### DETAILED DESCRIPTION

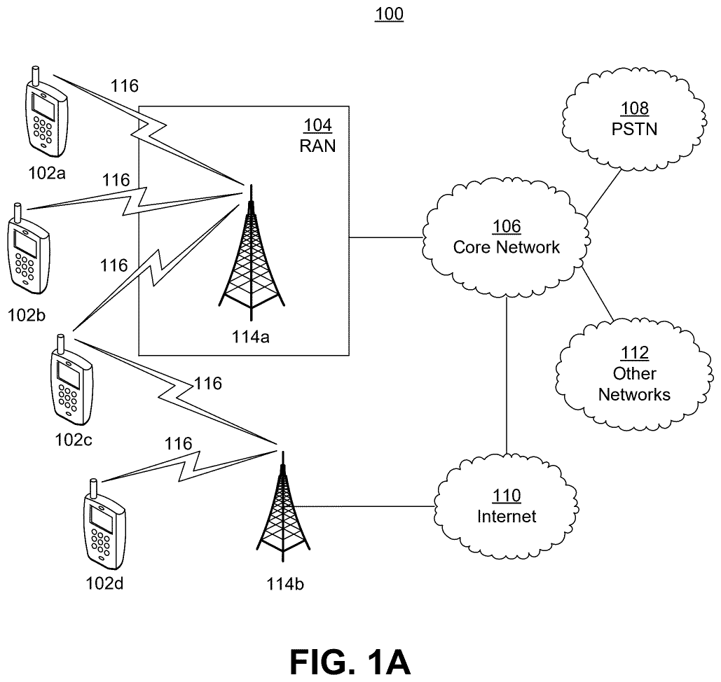

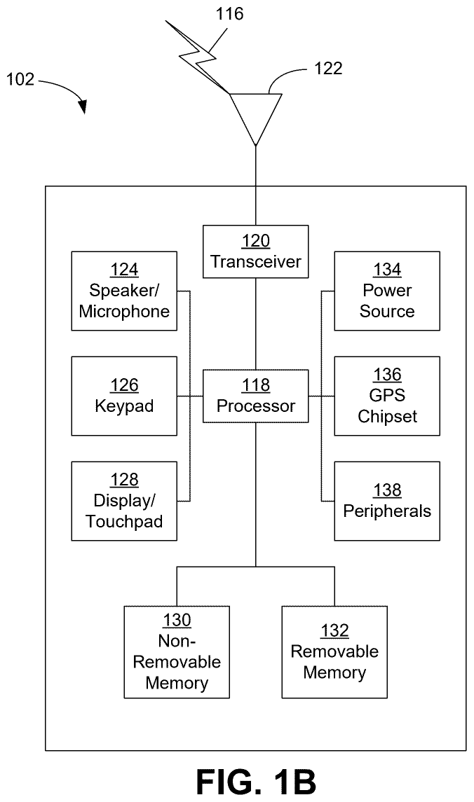

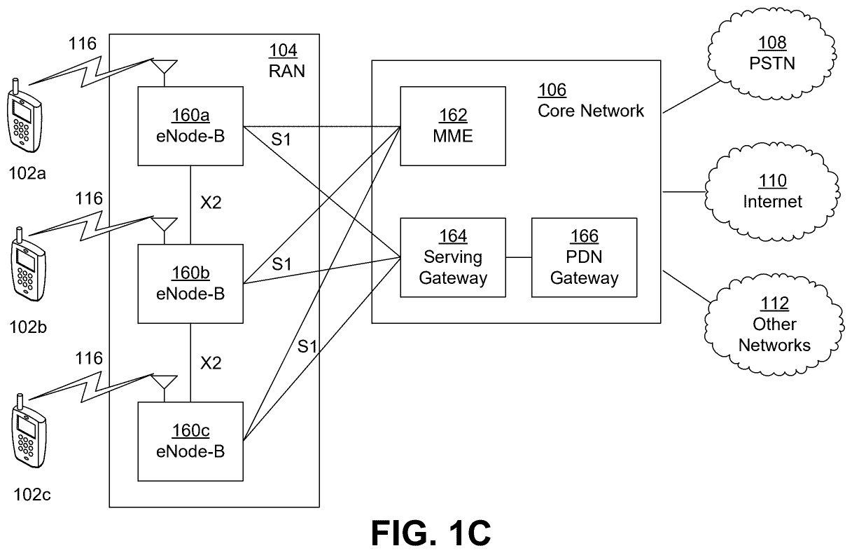

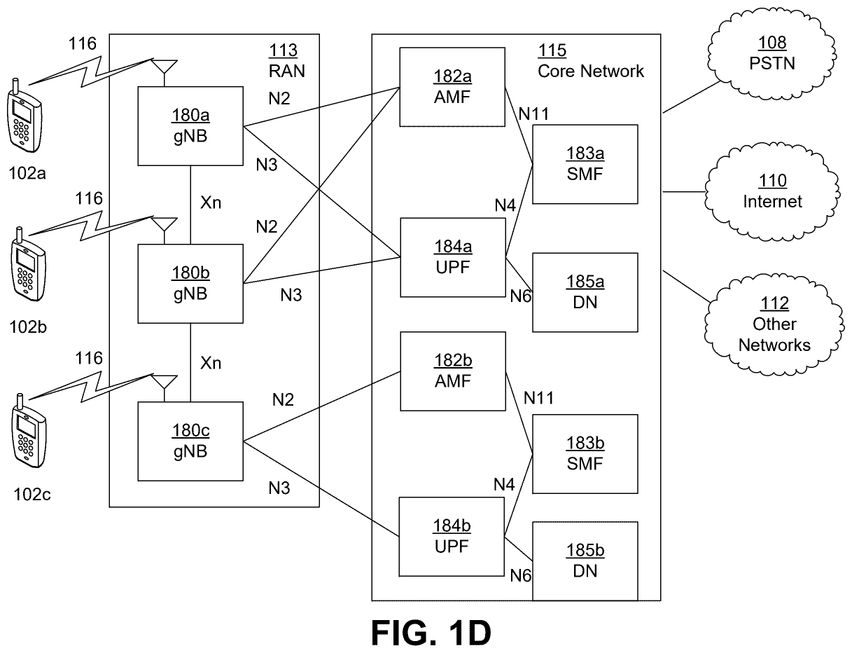

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHz, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHZ mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In NR, for example, when a WTRU is in radio resource control (RRC)_CONNECTED state, the WTRU may measure the signal level of one or more beams of a cell and/or the measurements results may be averaged to determine (e.g., derive) the cell quality. The WTRU may be configured to consider a subset of the detected beams. Filtering may take place at two different levels: at the physical layer (L1) level to derive beam quality and/or at RRC (L3) level to derive cell quality from one or more (e.g., multiple) beams. Cell quality from beam measurements may be derived in the same way for the serving cell(s) and/or for the non-serving cell(s). Measurement reports may include the measurement results of the X best beams, for example, if the WTRU is configured to do so by the gNB.

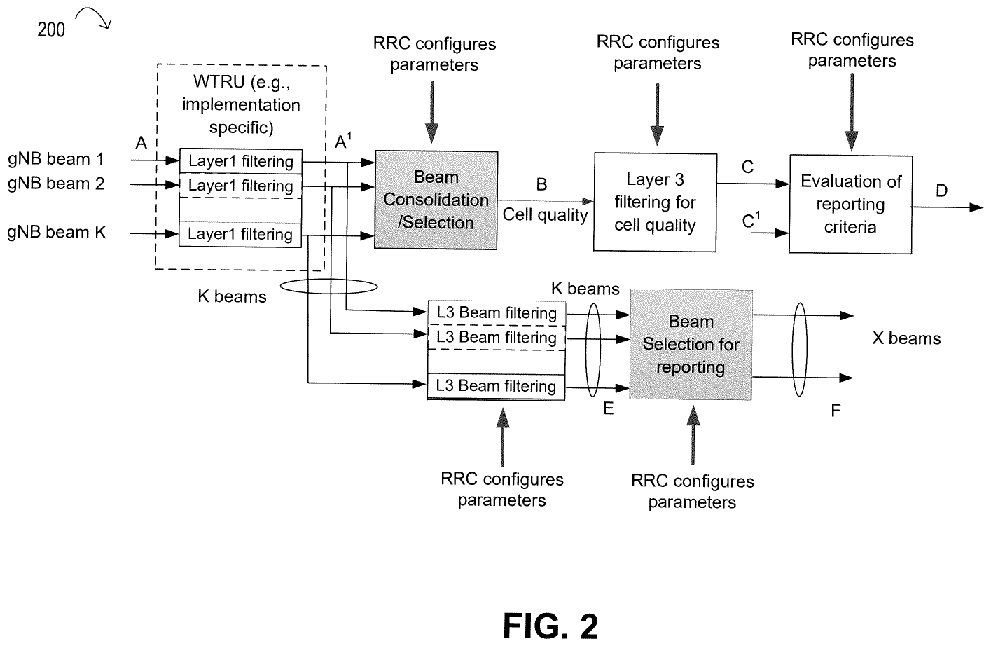

FIG. 2 depicts an example high-level (e.g., NR) measurement model 200.

A WTRU may perform measurements of serving and/or neighbor cells, for example, based on a configuration received by the gNB. The WTRU can be configured to report the measurements periodically and/or when certain events are fulfilled (e.g., A3 event, where a neighbor cell's signal quality becomes stronger than the serving cell by more than a certain threshold). The WTRU may be configured with a conditional handover (CHO) configuration regarding a certain neighbor cell, which may include a HO command and/or associated measurement event. When the measurement event conditions get fulfilled, for example, the WTRU may execute the HO command associated with the event (e.g., instead of sending a measurement report).

Radio resource management (RRM) configuration may include one or more of the following. RRM configuration may include measurement objects. Measurement objects may include what is to be measured (e.g., frequency, cells, synchronization signal block (SSB) and/or channel state information (CSI)-reference signal (RS), offset(s), measured quantities, cell level measurement derivation parameters, etc.). RRM configuration may include reporting configuration(s). Reporting configuration(s) may include what is to be reported and/or when it is to be reported (e.g., periodicity, event threshold(s), time to trigger (TTT) hysteresis, CHO configuration, etc.). RRM configuration may include measurement identifications (IDs). Measurement IDs may include an association of a measurement object with a reporting configuration. For example, if there is no measurement ID with a measurement object, that measurement may not be performed.

Condition reconfiguration (e.g., existing conditional reconfiguration) and/or conditional handover may be a target configuration coupled to a measurement event to execute a reconfiguration (e.g., handover) when the associated measurement event criteria is met.

Layer 1 (L1)/Layer 2 (L2) triggered mobility (LTM) may be described herein. LTM may be a procedure in which a gNB receives L1 measurement report(s) from a WTRU, and the gNB changes the WTRU serving cell, by a cell switch command signalled via a medium access control (MAC) MAC (control entity) CE based on the received L1 measurement report(s). The cell switch command may indicate an LTM candidate configuration that the gNB previously prepared and/or provided (e.g., sent) to the WTRU through RRC signalling. The WTRU may switched to the target configuration according to the cell switch command. The LTM procedure can be used to reduce the mobility latency and handover interruption time.

Artificial intelligence (AI) and/or machine learning (ML) for NR may be described herein. AI/ML mobility may enhance network triggered L3-based handover (e.g., handover triggered by the network based on information received by the WTRU, such as measurement reports). AI/ML mobility may include cell level measurement predictions of serving and/or neighbour cells. The WTRU may use AI/ML to determine the predicted measurements (e.g., based on the actual measurements).

RRM measurement prediction may include one or more of the following use cases. A first use case may be referred to as an indirect prediction of cell level results and include predicting beam level results and/or generating cell level results, for example, based on the predicted beam results. A second use case may include (e.g., directly) predicting cell level results based on cell level results. A third use case may include (e.g., directly) predicting cell level results based on beam level results.

RRM measurement event prediction may be described herein. RRM measurement event prediction may include measurement event evaluation based on RRM measurement prediction (e.g., indirect prediction of measurement event trigger). RRM measurement event prediction may include direct measurement event prediction (e.g., directly predict whether an event may be triggered rather than derive this from measurement prediction(s)). RRM measurement event prediction may include conditional reconfiguration.

When it comes to utilization of AI prediction in practice, it may be likely that real measurements and/or AI/ML predictions may be configured in WTRUs simultaneously. For this reason, to make the best use of predictions, how these different types of measurement(s) interact with each other and/or how they can be used to complement and/or improve mobility performance (e.g., overall) may be considered. If predictions are used to control conditional reconfigurations (CHO), the reconfiguration itself may not be triggered (e.g., immediately) based on a predicted future event because this may increase, rather than improve, failure rates. Rather, the reconfiguration may take place when the radio conditions are suitable to do so. Future events and/or radio conditions may be used to influence the current mobility decisions to ensure optimal decision making. For example, a future event can be used to decide whether to perform a reconfiguration based on the current condition(s). If the future event results in a successful reconfiguration with less chance of failure, and/or less interruption due to minimum cell changes, for example, this could advantageously be used to improve the (e.g., overall) system performance. Embodiments described herein may address how to utilize predicted future radio condition(s) and/or measurement event(s) to improve the mobility decision making based on current condition(s), for example, to improve mobility performance in terms of failure rates, interruption, and/or signalling overhead.

A WTRU may prioritize a future predicted event over a current real triggered event if certain condition(s) are met. For example, if a first (e.g., real) measurement event is triggered for a first conditional reconfiguration, while a second (e.g., predicted) measurement event has been triggered (and/or reconfiguration pending) for a second conditional reconfiguration, and/or if a configured criteria is met, the WTRU may defer the first conditional reconfiguration and/or may wait for and/or execute the second conditional reconfiguration.

A WTRU may receive, from a first cell, configuration information. The configuration information may include one or more of a first measurement event based on real measurement(s), criteria to trigger a first measurement event, a second measurement event based on predicted measurement(s), criteria to trigger a second measurement event, a configuration of an action to take when both the first and second event are triggered, and/or a condition to determine whether to take the configured action. For example, the configuration information may include a first measurement event, a second measurement event, a first action associated with the first measurement event, a second action associated with the second measurement event, criteria associated with the first measurement event, criteria associated with the second measurement event, and/or a condition (e.g., associated with the action). The measurement event configuration may include what is to be measured, what the condition(s) to be fulfilled for the event(s) to be considered valid, and/or the associated action. For example, one measurement event may be related to real measurements (e.g., conditions that real measurements have to fulfill, and/or actions associated with that) Another measurement may be associated with predicted measurements (e.g., conditions that measurements are expected and/or predicted to fulfill in the future, and/or actions associated with that). An action may include one or more of: suspend and/or delay and/or cancel triggering of the first (e.g., real) conditional reconfiguration and/or reporting of the first measurement report. An action may include triggering the first (e.g., real) conditional reconfiguration and/or including an indication and/or report to the first and/or second cell that the second (e.g., predicted) event has been triggered. A condition may include one or more of the following. A condition may include time to second reconfiguration execution is less than a threshold. A condition may include second reconfiguration is higher priority. A condition may include a priority value. A condition may include a reconfiguration type (e.g., LTM, L3). A condition may include a target type (e.g., inter-CU, intra-CU). A condition may include a time of stay in the first target is below a threshold. A condition may include whether the WTRU has a valid timing advance (TA) for one or the other (e.g., supporting LTM based random access channel (RACH)-less CHO). A condition may include radio link failure (RLF) probability of one target vs. another (e.g., and/or threshold for one of the targets). For example, a WTRU may prioritize one handover target over another based on whether it has a valid TA to one but not the other (e.g., prioritize the one that has a valid TA, and/or the one that has more time left for the TA to expiry, as each TA may be associated with a validity time). A condition may include a probability of success for a second reconfiguration is high (e.g., above a threshold). A condition may include pending at a amount and/or buffer size. A condition may include one or more configured parameters at a potential target cell (e.g., TA, whether a configured grant is available). A condition may include a prediction reliability (e.g., above a threshold). A condition may include a comparison of predicted and real measurement(s) (e.g., predicted future results greater than real results).

A WTRU may perform real measurements on received reference signals. For example, the WTRU may determine measurements based on one or more reference signals.

A WTRU may determine predicted measurements and/or predicted measurement event triggers based on the real measurements. For example, a WTRU may predict measurements based on the measurements that are determined based on the one or more reference signals. A WTRU may determine that a second measurement event is triggered based on the configured criteria to trigger the second measurement event and/or the real and/or predicted measurements. The WTRU may determine whether a second measurement event is fulfilled based on i) the criteria associated with the second measurement event and ii) the measurements and/or predicted measurements that are based on the measurements. For example, a cell 3 measurement may be above a threshold at time X in the future.

A WTRU may determine that a first measurement event is triggered, for example, based on the configured criteria to trigger the first measurement event and/or real measurement(s). For example, a cell 2 measurement may be above a threshold. The WTRU may determine whether the first measurement event is fulfilled based on the measurements and/or the criteria associated with the first measurement event.

A WTRU may determine to perform the configured action based on the triggered first and/or second measurement events and/or the one or more configured condition(s).

A WTRU may select the first action or the second action based on the condition, a determination of whether the first measurement event is fulfilled, and a determination of whether the second measurement event is fulfilled. The selected action may be the first action associated with the first measurement event. The selected action may be the second action associated with the measurement event. The selected action may be another (e.g., third) action based on the first and/or second measurement event being triggered and/or the condition. For example, if the first measurement event and the second measurement event are both fulfilled, the WTRU may execute the first action. For example, if the first measurement event and the second measurement event are both fulfilled, the WTRU may execute the second action. For example, if the first measurement event and the second measurement event are both fulfilled, the WTRU may execute a third action (e.g., if only first measurement event is fulfilled, execute the first action; if only second measurement event is fulfilled, execute the second action; if both the first and second measurement events are fulfilled, the WTRU may execute a third action). If the first and second measurement events are not fulfilled, the WTRU may execute a third action. If the first measurement event is fulfilled and the second measurement event is not fulfilled, the WTRU may execute the first action. If the first measurement event is not fulfilled and the second measurement event is fulfilled, the WTRU may execute the first action. If the first event is not fulfilled and the second event is fulfilled, the WTRU may execute the second action.

A WTRU may perform the selected action. For example, a WTRU may determine that the WTRU has a TA that may be valid in the third cell at the predicted event time (e.g., as described herein). The WTRU may cancel performing reconfiguration to the second cell (e.g., as described herein). The selected action may include one or more of: sending a measurement report, performing an early synchronization process, and/or performing a handover process. The WTRU may perform the action associated with the measurement event when the condition(s) are fulfilled. For example, if the action is to send a measurement report, the WTRU may send a measurement report. For example, if the action is to perform a conditional handover, the WTRU may perform the CHO and/or may send an indication that the handover and/or reconfiguration has been executed. For example, if the action is to perform a reconfiguration that will result in the WTRU performing the (e.g., condition) handover, the WTRU may perform the reconfiguration.

A WTRU may transmit one or more of the following. A WTRU may transmit a measurement report to the first cell, including an indication of the events which have been triggered, and/or the action and/or prioritization determined. A WTRU may transmit a reconfiguration complete (e.g., handover complete) message and/or indication to the determined target cell upon reconfiguration (e.g., the second and/or the third cell), based on the action and/or interaction between event(s) including an indication of the events which have been triggered, and/or the action and/or prioritization determined.

One or more examples described herein may include and/or use direct event prediction (e.g., direct prediction of whether an event will occur), and/or indirect event prediction (e.g., prediction of measurement value(s), and/or determining whether the event criteria will be met based on the measurement values(s)).

Embodiments described herein may leverage predicted measurement(s) and/or measurement event(s) to improve system performance (e.g., reduced signaling overhead and/or interruptions) by minimizing unnecessary handovers, and/or may improve mobility key point indicators (KPIs) (e.g., HOF, RLF) by executing (e.g., favorable) reconfiguration by comparison of predicted and/or real measurements and/or events. For example, in (e.g., legacy) HO, the WTRU may send a measurement report. Based on the measurement report, the network may send the HO command. A WTRU may send the measurement report and, before it receives the HO command, the WTRU may go out of coverage of the serving cell (e.g., which may result in radio link failure and/or re-establishment). With CHO, for example, since the WTRU may not execute the handover (e.g., immediately), the network can send the message when the serving cell is in one or more (e.g., quite good) conditions (e.g., before a handover is imminent in the very near future), and/or may mitigate an aspect of (e.g., legacy) operation of WTRU failing to receive a HO command after sending a measurement report.

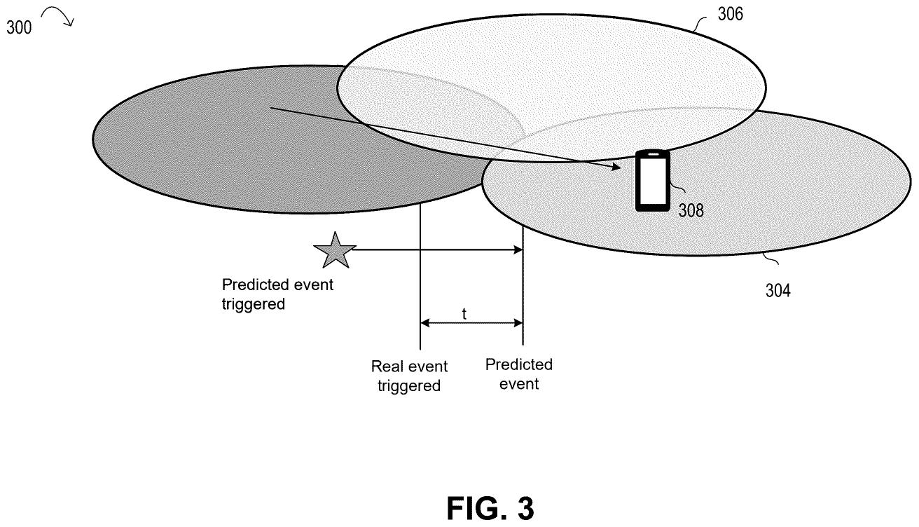

FIG. 3 depict an example scenario 300 of two configured events, where a first event is based on real measurements, and a second event is based on predicted measurements. If there was no event triggered due to predictions, for example, the WTRU 308 may perform the handover to cell 306, and/or may perform (e.g., later) the handover to cell 304. The WTRU 308 may determine one or more decisions based on current events and/or predicted events. The WTRU 308 may be configured to defer the HO towards cell 306 and/or perform the handover to cell 304 instead (e.g., later when the condition(s) to handover to cell 304 get fulfilled).

The terms AI/ML and AIML may be used interchangeably. The terms data, measurements, report, and/or results may be used interchangeably. The terms starting conditions and validity conditions may be used interchangeably. The terms indication, information, and/or message may be used interchangeably. The terms serving cell and source cell may be used interchangeably. The terms target cell and candidate cell may be used interchangeably.

The term Ax may be used to refer to one or more (e.g., any) of the events A1, A2, A3, A4, A5, and/or A6. Event A1 may refer to a serving cell becomes stronger than a threshold. Event A2 may refer to a serving cell becomes weaker than a threshold. Event A3 may refer to a neighbor cell becomes offset stronger (e.g., better) than a special cell (SpCell). The SpCell may be the Primary cell (PCell) and/or the Primary secondary cell (PSCell) (e.g., in the case of dual connectivity). Event A4 may refer to a neighbor cell becomes stronger than a threshold. Event A5 may refer to a SpCell becomes weaker than a first threshold and a neighbor cell becomes stronger than a second threshold. Event A6 may refer to a neighbor cell becomes offset stronger (e.g., better) than a secondary cell (SCell). The SCell may be a secondary cell in case of carrier aggregation.

The term Bx may be used to refer to one or more (e.g., any) of the events B1 and/or B2. Event B1 may refer to Inter RAT neighbor becomes stronger than a threshold. Event B2 may refer to a PCell becomes weaker than a first threshold and inter RAT neighbor becomes stronger than a second threshold.

Embodiments described herein may (e.g., equally) apply to layer 1 beam-based measurement events, such as those that support MIMO beam management and/or L1/L2 triggered mobility. For example, beam based events may be described herein. Event LTM1 may refer to beam of serving cell becomes stronger than an absolute threshold. Event LTM2 may refer to a beam of a serving cell becomes weaker than an absolute threshold. Event LTM3 may refer to a beam of candidate cell becomes amount of offset stronger (e.g., better) than beam of serving cell. Event LTM4 may refer to a beam of a candidate cell becomes stronger (e.g., better) than an absolute threshold. Event LTM5 may refer to a beam of a serving cell becomes weaker than an absolute first threshold and a beam of a candidate cell becomes stronger than an absolute second threshold. Embodiments described herein may include beam and/or cell measurement prediction, and/or measurement event prediction based on AIML model(s). Embodiments described herein may include one or more other forms of prediction that do not use AIML (e.g., time series forecasting, interpolation methods, etc.). Reference to handover, reconfiguration, cell switch, conditional reconfiguration may apply to layer 3 handover, and/or to one or more (e.g., any) other mobility mechanisms such as L1/2 triggered mobility (LTM), conditional LTM, uplink-based mobility, inter-cell beam management, and/or one or more (e.g., any) other mechanism applicable to communication systems (e.g., 5G NR, 6G, etc.).

One or more (e.g., all) the embodiments described herein may be agnostic to the kind of AIML model/technique used by the WTRU. For example, the algorithm used, the mechanism such as neural network or what kind of neural network (e.g., depth and/or parameters/weights of the network, etc.), the origins of the model (e.g., WTRU vendor, operator, network vendor, etc.), and/or how and/or where the training of the model is done (e.g., the input data used for the training, where the training is performed, if the training is performed offline or online, etc.) may be agnostic to the kind of AIML mode/technique the WTRU uses. The model may be trained based on historical observation of one or more WTRUs' actual measurements in different WTRU and/or network conditions (e.g., during certain time durations of the day, during certain days of the week, at different locations, different WTRU mobility patterns/speeds, under different network conditions that are visible to the WTRU such as frequency/bandwidth, etc., under different network configurations, which may be visible to the UE just as a network configuration index that is provided by the network at the time of training or data collection for the training, etc.).

There may be WTRU capability communication between the WTRU and the network about AIML capability (e.g., where the WTRU can indicate to the network the supported AIML models and/or functions, confidence level of prediction(s), time horizon of predictions (how far along in the future are the prediction(s) being made), etc.). The WTRU may support one or more (e.g., several) AIML models for a certain functionality (e.g., with different prediction time horizons, prediction confidence levels, processing requirements, trained under and/or for operation in different frequences/cells/location/times of day, etc.). A given AIML model may operate in different modes (e.g., with different levels of prediction confidence levels at different prediction time horizons, at different locations, frequences, WTRU mobility pattern/speed, etc.). The WTRU may choose the AIML model to use for a certain functionality (e.g., network decides for which functionalities the WTRU can use AIML based operation, and/or the WTRU may choose the AIML mode to use) and/or the network may explicitly control this (e.g., WTRU provides details of AIML model(s) and/or the capabilities of the AIML model(s), the network may determine which model to activate for a particular functionality). The AIML model may be available at the WTRU already trained and/or the WTRU may be provided with an untrained AIML model and/or may perform the training by itself. The AIML model may be available at the WTRU already trained and/or the WTRU may be enabled and/or configured to perform (e.g., further) training (e.g., for different conditions such as frequencies/cells/location/times of day, for the same conditions as the initial training but for increasing the level of confidence and/or the prediction time horizon, for different WTRU speeds, etc.). The AIML model may be available at the WTRU but not trained (e.g., at all) and/or (e.g., only) trained for certain WTRU and/or network condition(s) and/or the WTRU may be configured to train the model (e.g., for the conditions that is not trained for).

Embodiments described herein may apply to the Life Cycle Management (LCM) of the beam and/or cell measurement prediction models and/or functionality. The WTRU may use a certain model for beam prediction that has been trained and/or performance tested for the (e.g., current) WTRU and/or network condition(s). One or more embodiments described herein may be used to enable one or more (e.g., some) LCM aspects. For example, the measurement results the WTRU provides that include actual measurement, predicted measurements, and/or combined measurements that are derived and/or calculated considering both actual measurements and predicted measurements, according to one or more (e.g., any) of the embodiments described herein, may be collected and/or used for performance monitoring and/or model (re) training. In examples, the WTRU may (e.g., also) be configured to perform actual measurements of one or more (e.g., some) of the beams in parallel with using the AIML model to predict the beams (e.g., in temporal and/or spatial manner), compare the actual measurements and/or the predicted measurements, and/or may decide to switch from one model to another model, and so on, for example, based on this comparison.

A WTRU may be configured to indicate beam measurement prediction capability. In examples, a WTRU may indicate to the network that the WTRU is capable of predicting beam level measurements. The capability to predict beam level measurements may include one or more of the following. The capability to perform prediction of beam level measurements may include beam prediction type. For example, beam prediction type may be temporal prediction (e.g., prediction of the signal level of a beam at a future time instance based on current and/or historical signal levels of the beam). For example, beam prediction type may be spatial prediction (e.g., prediction of the signal level of one beam based on the signal level of another beam (beam of the same cell, beam of a different cell), etc.). The capability to perform prediction of beam level measurements may include the number of beams that can be predicted. The capability to perform prediction of beam level measurements may include the number of beams that are (e.g., need) to be measured to perform the predictions. The capability to perform prediction of beam level measurements may include a confidence level of the predictions. The capability to perform prediction of beam level measurements may include one or more conditions under which the AIML functionality and/or models can operate at (e.g., the models and/or functionality were trained under the indicated conditions, where the performance of the models and/or functionality has been tested and/or shown to work properly, etc.), where the conditions could include WTRU and/or network conditions (e.g., WTRU mobility state, WTRU location, cells/frequencies, time of day, network configuration index, etc.).

The capability may be provided at a functionality level (e.g., WTRU not explicitly indicating the number/identity of the models it is using, but providing the overall capability of the one or more models for the beam prediction capability) and/or the capability can be model level (e.g., WTRU providing explicit information about each model it has for the beam prediction functionality and associated capability information for each model).

The capability information may be provided autonomously by the WTRU (e.g., upon connection setup/resume, upon handover, upon detecting that the WTRU has entered a new cell/region/RAT where the capability regarding beam prediction is different from previously reported capability, etc.), and/or based on an explicit request from the network.

If capability information is requested from the network, for example, the request may be a generic request. If the request is generic, the WTRU may provide one or more (e.g., all) of its capabilities). The request for capability information from the network may be a more granular request. For example, the WTRU may receive a request from the network if the WTRU supports beam prediction at a certain frequency layer. The WTRU may respond with an indication that the WTRU does not support the beam prediction at the requested frequency layer, or an indication that the WTRU does support the beam prediction at the requested frequency layer and/or detailed information about the capability regarding beam prediction at the requested frequency layer (e.g., summarized information at functionality level, detailed information for each AIML model that supports beam prediction at that frequency layer, etc.).

A WTRU may be configured on how to select predicted beams for cell level measurement consolidation. In examples, a WTRU may be configured with cell level measurement derivation based on measured and/or predicted beams at a given cell level measurement derivation instance.

In NR, for example, when it comes to which beams are selected for cell level measurement derivation, the following information elements (IEs) may be referenced for each measurement object (e.g., each NR frequency being measured). For example, nrofCSI-RS-Resources ToAverage may reference the maximum number of measurement results per beam based on CSI-RS resources to be averaged. For example, nrofSS-Blocks ToAverage may reference the maximum number of measurement results per beam based on synchronization signal (SS)/physical broadcast channel (PBCH) blocks to be averaged. For example, abs ThreshCSI-RS-Consolidation may reference an absolute threshold for the consolidation of measurement results per CSI-RS resource(s) from L1 filter(s). For example, absThreshSS-BlocksConsolidation may reference an absolute threshold for the consolidation of measurement results per SS/PBCH block(s) from L1 filter(s).

A WTRU may perform the cell derivation according to one or more of the following.

If the cell measurement was configured to be derived based on SS blocks, and if the nrofSS-Blocks ToAverage and/or abs ThreshSS-BlocksConsolidation is not configured, and/or if the highest measured beam based on SS is below the abs ThreshSS-BlocksConsolidation, the WTRU may consider the highest SS beam measurement as the cell level measurement. Otherwise, the WTRU may derive the cell level measurement as the linear power average of the SS beams with a value above the abs ThreshSS-BlocksConsolidation (but considering not more than nrofSS-Blocks ToAverage beams).

If the cell measurement was configured to be derived based on measured CSI-RS, and if the nrofCSI-RS-Resources ToAverage and/or abs ThreshCSI-RS-Consolidation is not configured, and/or if the highest measured beam based on CSI-RS is below the abs ThreshCSI-RS-Consolidation, the WTRU may consider the highest CSI-RS beam measurement as the cell level measurement. Otherwise, the WTRU may derive the cell measurement as the linear power average of the CSI-RS beams with a value above the abs ThreshCSI-RS-Consolidation (but considering not more than nrofCSI-RS-Resources ToAverage beams).

In examples, the WTRU may be configured to consider measured and predicted beams equally in the cell level measurement determination. For example, consider the case where the WTRU measures n1 beams and predicts n2 beams. At a given cell level measurement derivation instance, the WTRU may perform one or more of the following. The WTRU may arrange the beams in order of beam value (e.g., disregarding if the beams were measured or not). The WTRU may select the beams that have values above the consolidation threshold and/or may consider not more than the maximum beams that can be consolidated. The WTRU may derive the cell level measurement as the linear average of the selected beams.

In examples, the WTRU may be configured with different consolidation thresholds and/or resources/blocks to average when it comes to predicted beams. For example, the WTRU may be configured with nrofPredictedCSI-RS-ResourcesToAverage, nrofPredictedSS-Blocks ToAverage, abs ThreshPredictedCSI-RS-Consolidation, and/or abs ThreshPredictedSS-BlocksConsolidation.

In examples, instead of different values for the predicted ones, the WTRU may be configured a scaling factor for deriving the number of resources to average and/or the thresholds to consider for predicted beams based on the values corresponding the measured beams. For example, this could be configured to be the same for one or more (e.g., all) frequencies (e.g., the WTRU may not need to receive the configuration with each measurement object configuration corresponding to the different frequencies, and/or may reducing the required signalling).

In examples, the WTRU may be configured to derive the cell measurements based on measured and/or predicted CSI-RS beams independently and/or may calculate the cell level measured as the linear average of the two. For example, the WTRU may derive the following intermediate values to derive the cell measurements. The WTRU may derive Measured_value as the linear power average of the measured CSI-RS beams with a value above the abs ThreshCSI-RS-Consolidation (but considering not more than nrofCSI-RS-Resources ToAverage beams). The WTRU may derive Predicted_Value as the linear power average of the predicted CSI-RS beams with a value above the abs ThreshPredictedCSI-RS-Consolidation (but considering not more than nrofPredictedCSI-RS-Resources ToAverage beams). The cell measurement may be derived as the linear average of measured_value and predicted_value.

In examples, the WTRU may be configured to perform a weighted averaging of the measured_value and the predicted_value, where the weighting considers the number of measured/predicted beams in the calculation of the measured_value and predicted_value. For example, if n1 beams were considered in deriving the measured_value (e.g., there were n1 measured beams that have value above abs ThreshCSI-RS-Consolidation, if measurement were based on CSI-RS, and/or abs ThreshSS-BlocksConsolidation, if measurements were based on SS), and/or n2 beams were considered in deriving the predicted_value (e.g., there were n2 predicted beams that have value above abs ThreshPredictedCSI-RS-Consolidation, if measurement were based on CSI-RS, and/or abs ThreshPredictedSS-BlocksConsolidation, if measurements were based on SS), the cell measurement may be derived as:

Cell measurement=(n1*measured_value+n2*predicted_value)/(n1+n2).

Since measured_value=sum of the n1 measured beams divided by n1, and predicted_value is equal to the sum of the n2 predicted beams divided by n2, cell measurements may be calculated as follows:

Cell measurements=(sum of the values of the measured beams with values above the measured beams consolidation threshold+sum of the values of the predicted beams with values above the predicted beams consolidation threshold)/(number of measured and predicted beams considered in the consolidation).

In examples, the WTRU may be configured with an explicit weighting factor to use when determining the cell measurement from measured and/or predicted beams. For example, the WTRU may be configured with a weighing factor of alpha_1. The cell measurement may be determined as cell measurement=alpha_1*measured_value+ (1−alpaha_1)*predicted_value

In examples, the WTRU may be configured to consider both an explicit weighing factor as well as the number of measured and/or predicted beams that were considered in the cell derivation. For example, the WTRU may derive the cell measurement:

Alpha_2=alpha_1*n1/(n1+n2)

(e.g., putting more weight on measured beams if there were more measured beams than predicted beams) and

Cell measurement=alpha_2*measured_value+(1−alpaha_2)*predicted_value

In examples, the WTRU may consider (e.g., only) measured beams in the cell measurement derivation if the number of the measured beams that fulfil the measured beam consolidation are greater than or equal to the maximum number of measured beams that can be considered for consolidation. A WTRU may not consider predicted beams in the cell level measurement derivation if the number of beams that have values above abs ThreshCSI-RS-Consolidation is greater than and/or equal to nrofCSI-RS-Resources ToAverage (in the case of measurements based on CSI-RS), and/or the number of beams that have values above abs ThreshSS-BlocksConsolidation is greater than and/or equal to nrofSS-Blocks ToAverage (in the case of measurements based on SS).

In examples, if the WTRU determines that the number of measured beams that fulfill the consolidation threshold for the measured beams is less than the maximum number of measured beams that can be considered for consolidation, the WTRU can consider predicted beams in the consolidation. For example, if N1=(nrofCSI-RS-Resources ToAverage)−(number of measured beams that have values above abs ThreshCSI-RS-Consolidation), the WTRU may consider up to N1 predicted beams for the cell level measurement consolidation (among the predicted beams that fulfill the predicted beam consolidation threshold, for example). A similar behavior can be applied for SS based measurements.

One or more of the embodiments described herein may focus on spatial beam prediction (e.g., WTRU predicting some beams based on other beams and/or other input such as WTRU mobility, location, etc.). Another beam prediction type may be temporal prediction. For example, for a given cell, the WTRU may perform measurements of n1 beams, and the prediction may be the measurements of these n1 beams at one or more future time instances.

In examples, the WTRU may be configured to perform beam measurements at certain time intervals and/or may use predicted measurements at certain instances between two actual measurements. For example, at TO, a WTRU may perform beam measurements and/or may predict the measurements at T0+dt, T0+2dt, and/or T0+3dt. At T1 (e.g., T0+4dt), the WTRU may perform beam measurements and/or may predict the measurements at T1+dt, T1+2dt, and/or T1+3dt. And so on.

In examples of temporal beam prediction, the WTRU may be configured to derive the cell level measurements at the instances where actual measurements are performed (e.g., TO, T1, etc., as described herein), using the configured beam consolidation threshold and/or the configured number of beams to consolidate for measured beams (e.g., as described herein).

At instances where one or more (e.g., all) beams were being predicted, predicted (e.g., T0+dt, T0+2dt, T0+3dt, T1+dt, etc.), the WTRU may be configured to derive the cell level measurements using the configured beam consolidation threshold and/or the configured number of beams to consolidate for predicted beams, as described herein.

In examples, when deriving the cell level measurements that consider measured beams and/or predicted beams, according to one or more of the embodiments herein, the WTRU may be configured to consider the prediction confidence (e.g., scaling factors depending on confidence levels, different values/thresholds for different confidence levels and/or range of confidence levels, etc.).

In examples, the WTRU may be configured to consider a predicted beam for consolidation in the cell level measurement according to one or more of the embodiments herein (e.g., only) if the confidence level of the beam prediction is above a certain threshold.

In examples, the WTRU may be configured with different parameters (e.g., any of the parameters described above) that is associated with different beam prediction confidence values and/or range of values. For example, a WTRU may be configured with different values for the number of predicted beams that can be considered in the cell level derivation (e.g., n1 if confidence is below threshold1, n2>n1: if the confidence is above threshold1 but below threshold2, n3: if the confidence level is above threshold2, etc.). For example, a WTRU may be configured with different values for the predicted beam consolidation threshold (e.g., threshold_a: if confidence is below threshold1, threshold_b: if the confidence is above threshold1 but below threshold2, threshold_c: if the confidence level is above threshold2, etc.). For example, a WTRU may be configured with different weighting factors for different confidence levels (e.g., if predication confidence is high, the weight attributed for predicted values can be higher than the case where prediction confidence is low).

The confidence level of the beam prediction can be beam specific and/or the same for each predicted beam (at a given prediction instance). The embodiments described herein regarding the confidence level consideration can be beam specific (e.g., instead of being the same for all beams). For example, at a given prediction instance, the WTRU may determine different prediction confidence values for the different predicted beams and/or may consider (e.g., only) the beams that have associated predicted confidence level above the configured threshold level for cell level measurements. In examples, the WTRU may be configured to categorize the predicted beams into different groups based on confidence levels and/or confidence level ranges, and/or may apply a weighting factor that is specific for each group, etc.

A WTRU may be configured to perform L3 filtering of cell level measurements that are based on measured and/or predicted beams. In examples, the WTRU may apply L3 filtering of cell level measurements that were derived based on measured and predicted beams, according to one or more (e.g., any) of the embodiments described herein, using the (e.g., legacy) L3 filtering coefficients provided for L3 filtering. That is,

Filtered_measurement=(1−alpha)*old_filtered_measurement+alpha*current_measurement

The term current_measurement may be the cell level measurement derived according to the embodiments described herein considering measured and/or predicted beams; old_filtered_measurement may be the last filtered measurement, and/or filtered_measurement may be the current L3 filtered measurement. Alpha may be a weighting factor that is derived from filtered coefficients the WTRU is configured with according to the derivation (e.g., specified in 3GPP).

In examples, the WTRU could be configured with two different sets of coefficients, a first set of coefficients to derive the alpha value for cells whose cell level derivation is based (e.g., only) on measured beams (e.g., as in legacy) and the set of coefficients to derive the alpha to be used for cells whose cell level derivation is based on measured and/or predicted beams.

In examples, the WTRU may be configured to perform the cell level measurement derivation separately for measured beams and predicted beams, and/or may combine them during L3 filtering. For example, the WTRU may calculate Filtered_measured using alpha1 and/or Filtered_predicted using alpha2 and/or combine the two using a configured weighted averaging factor. For example,

L3 filtered result=w1*filtered_measured+(1−w1)*iltered_predicted

In case of temporal beam prediction, the WTRU may be configured to apply different alphas (e.g., configured with different coefficients that results in different alphas), if the L3 filtering is being done at the time instance where the beam measurements were actually being performed and/or the instances the beam measurements were being predicted. For example, at TO, a WTRU may perform beam measurements and/or may predict the measurements at T0+dt, T0+2dt, and T0+3dt. At T1 (e.g., T0+4dt), a WTRU may perform beam measurements and/or may predict the measurements at T1+dt, T1+2dt, and/or T1+3dt. And so on.

At T0, since beams were being measured, the WTRU may use the alpha that is associated with actual measurements. For example:

Filtered_measurement[T0]=(1−alpha)*old_filtered_measurement+alpha*measurement[T0]

At T0+dt, since the measurement at that time is predicted measurement, the filtering may be done using the alpha value associated with predicted measurements. For example:

Filtered_measurement[T0+dt]=(1−alpha1)*old_filtered_measurement+alpha1*predicted_measurement[T0+dt]

Measurement T0 may be the cell level measurement that is consolidation of actual measured beams; measurement T0+dt may be the cell level measurement that is consolidation of predicted beams (e.g., according to the configured beam consolidation threshold and/or number of beams to consolidate for measured and/or predicted beams, as described herein).

The confidence levels of predictions could be used to modify the L3 filtering behavior, as in the case of cell level measurement derivation described herein. For example, in the temporal prediction case described herein, the WTRU may be configured with different alpha1 values (e.g., coefficients that lead to those alpha values) corresponding to different prediction confidence levels and/or scaling factors that are used to increase/decrease the alpha1 values depending on the prediction coefficient. In this case, since the prediction cell level measurement at a given instance is a combination of several predicted beams at that time instance, the WTRU may be configured to derive the confidence level of the cell level measurement from the confidence level of the individual beam predictions (e.g., average/minimum/maximum/mean, etc., of the individual beam level prediction confidence levels, etc.), and/or, based on this determined confidence level, may choose/determine the alpha1.

In examples, the beam derivation may be spatial. For example, at a given filtering instance, the current value will be a combination of measured and predicted beams, (e.g., according to any of the solutions described in the previous section), the cell level measurement derivation may be associated with the confidence level for that measurement according to how many of the consolidated beams on deriving that particular cell level measurement were predicted, and/or the confidence level of these measurements.

In examples, if none of the derived beams were considered in the cell level derivation at a given cell level derivation instance because there were more measured beams than the required number of beams for consolidation that fulfilled the beam consolidation threshold, the confidence level of that derived cell measurement can be considered to be 100%.

In examples, if none of the measured beams were considered in the cell level derivation at a given cell level derivation instance because the (e.g., only) beams that fulfilled the beam consolidation threshold were predicted beams, the confidence level of that derived cell measurement can be considered to be the average/minimum/maximum/mean, etc. of the predicted beams that were considered in the cell level derivation.

Cell level measurements may be directly predicted (e.g., instead of indirectly derived from predicted beam measurements). A cell quality measurement may be predicted directly, without beam level prediction. This may be based on real beam measurements, real cell quality measurements, and/or one or more (e.g., any) of the other inputs described to be potentially used for beam prediction. In other words, predicting beams may not be a pre-requisite for predicting cell level measurements.

A prediction of whether a measurement event criteria is met may be done indirectly by use of predicted beam measurements, and/or predicted cell measurements. A prediction of whether a measurement criteria is met may be done directly, without first predicting specific beam and/or cell level measurements.

In examples, a combination of directly and indirectly predicted outcomes may be used. For example, a WTRU may determine directly whether one predicted event is expected to occur, and/or may determine indirectly whether another (or the same) event is expected to occur. Use of both direct and indirect prediction may improve the (e.g., overall) level of confidence of a prediction, and/or may improve the effectiveness of a comparison between different predicted and/or real events, and different criteria used to determine actions to take based on predicted and/or real events. In examples, the WTRU may select to use a direct and/or an indirect prediction based on configured criteria.

In examples, the WTRU may be configured to report cell level measurements that consider predicted and/or measured beams (e.g., cell level measurements and/or filtered cell level measurements, according to any of the solutions above), periodically.

In examples, the WTRU may be configured with different periodicity configurations based on if the cell measurements consider predicted beams or not. For example, the WTRU may be configured with a measurement object of a certain frequency, and/or there may be 2 cells operating at that frequency (e.g., cell A and cell B), where the WTRU may be configured to measure one or more (e.g., all) the beams of cell A, but measure (e.g., only) a fraction of the beams of cell B, the reporting configuration associated with the measurement object for that frequency (e.g., applicable to both cells A and B) may include different reporting periodicities for cell A and cell B. For example, the WTRU may report measurements of cell A more frequently than measurements of cell B, or vice versa. In examples, the WTRU may be configured with one periodicity, to be used for cells whose cell measurement is based (e.g., only) on actual (e.g., real) measurements, and/or a scaling factor to be applied to determine the periodicity for reporting cell measurements that are based on actual measured and/or predicted values.

In examples, the WTRU may be configured to trigger a measurement report based on cell level measurements that considered (e.g., only) actual measured beams. For example, the WTRU may perform cell level measurement derivation and/or filtering (e.g., as in legacy, based on measured beams/cells) and/or may perform the cell level measurement derivation and/or filtering that considers predicted values according to one or more (e.g., any) of the embodiments described herein. The WTRU may be configured with measurement events (Ax/Bx, etc.), and/or may check if the filtered measurements that considered (e.g., only) actual measurements fulfill the triggering conditions and/or thresholds. When the condition(s) get fulfilled, the WTRU may send a measurement report.

In examples, the WTRU may be configured to trigger a measurement report based on cell level measurements that consider actual and/or predicted measurements. The WTRU may be configured with measurement events (Ax/Bx, etc.), and/or may check if the filtered measurements that considered both actual measurements and predicted measurements fulfill the triggering conditions and/or thresholds. When the conditions get fulfilled, the WTRU may send a measurement report.

In examples, the WTRU may be configured to trigger a measurement report based on cell level measurements that (e.g., also) consider (e.g., only) predicted measurements (e.g., if the WTRU was doing the cell level derivation from the predicted beams only separately and/or doing the filtering of the predicted cell level measurements separately, etc.). The WTRU may be configured with measurement events (Ax/Bx, etc.), and/or may check if the filtered measurements that considered (e.g., only) predicted measurements fulfill the triggering conditions and/or thresholds. When the conditions get fulfilled, the WTRU may send a measurement report.

In examples, the WTRU may be configured to trigger a measurement report based on the comparison of one or more of the following. The WTRU may be configured to trigger a measurement report based on filtered cell level measurements that considered (e.g., only) actual measured values is lower/higher than filtered cell level measurement that considered (e.g., only) predicted measurements by more than a certain threshold. The WTRU may be configured to trigger a measurement report based on filtered cell level measurements that considered (e.g., only) actual measured values is lower/higher than filtered cell level measurement that considered both actual and predicted measurements by more than a certain threshold. The WTRU may be configured to trigger a measurement report based on filtered cell level measurements that considered (e.g., only) predicted measurements is lower/higher than filtered cell level measurement that considered both actual and predicted measurements by more than a certain threshold.

The measurement report may be triggered according to one or more (e.g., any) of the embodiments described herein and may include the filtered cell measurements that considered (e.g., only) actual measurements. The measurement report may be triggered according to one or more (e.g., any) of the embodiments described herein and may include the filtered cell measurements that considered (e.g., only) predicted measurements. The measurement report may contain the filtered cell level measurements that considered both actual and predicted measurements. In examples, the WTRU may be configured to include in the report (e.g., only) the filtered beam measurements of actual measured beams (e.g., in the case of spatial beam prediction). In examples, the WTRU may be configured to include in the report (e.g., only) the filtered beam measurements of predicted beams. In examples, the WTRU may be configured to include in the report the filtered beam measurements of both measured and predicted beams.

In examples, the WTRU may be configured with the maximum number of total beams to include in the report (e.g., as in legacy maxNrofRS-Indexes ToReport IE in ReportConfigNR). If the WTRU was configured to include L3 filtered results of actual measured and predicted beams, the WTRU may sort one or more (e.g., all) the L3 beam measurements (e.g., regardless of the measurement being actual or predicted) and/or may include the top maxNrOfRS-IndexesToReport number of beams (e.g., if they have values above the beam consolidation threshold). For example, the WTRU may include results of beams x, y, and/or z, where x and y are actual measured beams and z is a predicted beam.

In examples, the WTRU may be configured with separate maximum number of actual measured beams and/or maximum number of predicted beams to include in the measurement report.

If the WTRU is configured to include beam measurements in the measurement report, the WTRU may (e.g., also) applies L3 beam filtering of the beam measurements (e.g., the beam measurements that are included in the measurement report are one shot beam measurements at the time of measurement reporting, but the filtered measurements of the individual beams that are being measurements). One or more (e.g., all) embodiments described herein for the L3 filtering of cell level measurements described herein can be (e.g., equally) applied for the beam level measurements (e.g., possibly with different filtering configurations, such as filtering coefficients, to be use for the beam filtering as compared to the cell level measurement filtering).

One or more (e.g., all) the embodiments described herein for the cell level measurement derivation that consider measured and/or predicted beams can be configured at a cell and/or frequency level. Cell level derivation configuration for the source and/or target cells can be different. The WTRU may derives the cell level measurements for the serving cell, for example, according to the cell level measurement derivation configuration for the serving cell, and/or the cell level measurements for the target cell according to the cell level measurement derivation configuration for the target cell, apply L3 filtering for both cells (also according to the filtering configuration associated with the source and target cell, which can be different) and/or may (e.g., only) use the two filtered cell level measurements when evaluating the conditions for the measurement events for measurement reporting and/or CHO execution.

In examples, a WTRU may be configured to consider (e.g., only) measured beams in the cell level measurement derivation of the serving cell and/or may consider one or more of the following for cell level derivation of the target cell: (e.g., only) measured beams; (e.g., only) predicted beams; and/or measured and/or predicted beams.

In examples, a WTRU may be configured to consider (e.g., only) predicted beams in the cell level measurement derivation of the serving cell and/or may consider one or more of the following for cell level derivation of the target cell: (e.g., only) measured beams; (e.g., only) predicted beams; and/or measured and/or predicted beams.

In examples, a WTRU may be configured to consider both measured and predicted beams in the cell level measurement derivation of the serving cell and/or may consider one or more of the following for cell level derivation of the target cell: (e.g., only) measured beams; (e.g., only) predicted beams; and/or measured and/or predicted beams.

The different combinations of considering measured and/or predicted beams for serving and/or target cells described herein can be configured within a single measurement event configuration. For example, there could be one measurement event (e.g., a modified A3 event) that includes up to the 9 A3 thresholds (e.g., for the 9 possible combinations described herein).

In examples, where a single measurement event is provided with one or more (e.g., multiple) thresholds, the WTRU may be (e.g., further) configured to consider the measurement event conditions to be fulfilled if one or more (e.g., any) one of the thresholds are fulfilled.

In examples, where a single measurement event is provided with one or more (e.g., multiple) thresholds, the WTRU may be (e.g., further) configured to consider the measurement event conditions to be fulfilled (e.g., only) if one or more (e.g., all) the thresholds are fulfilled.

In examples, where a single measurement event is provided with one or more (e.g., multiple) thresholds, the WTRU may be (e.g., further) configured to consider the measurement event conditions to be fulfilled (e.g., only) if a certain number and/or percentage of (e.g., at least 2, at least half of, etc.) of one or more (e.g., all) the thresholds are fulfilled.

In examples, where a single measurement event is provided with one or more (e.g., multiple) thresholds, the WTRU may be (e.g., further) configured to consider the measurement event conditions to be fulfilled (e.g., only) if the threshold that is associated with the actual measurements of the serving cell and/or the actual measurements of the neighbor cell are fulfilled, and/or a certain number or percentage of (e.g., at least 2, at least half of, etc.) of the other thresholds are fulfilled (e.g., at least the threshold associated with the predicted measurements of the serving cell and the predicted measurements of the target cell, etc.).

Measurement events may be predicted and/or defined in one or more (e.g., various) ways. For example, a measurement event may be predicted based on predicted beam and/or cell measurement predictions to be used for indirectly determining whether the event trigger criteria may be met based on the predicted measurements. The measurement event may be directly predicted.

The prediction model may take a delta time and/or probability as an input, and/or the event may be triggered if the probability of that measurement event being fulfilled is more than the configured probability within the delta time. In examples, the time may be the output of the model (e.g., only probability is given, and WTRU may provide a delta time where the event is expected to be fulfilled by more than that confidence level). In examples, the output could be the probability (e.g., we could assume a periodic reporting, where instead of measurement results (and/or in addition to measurement results), the WTRU may include probabilities of the event being fulfilled until the next reporting period (and/or it can be combined with the other examples above). The event may be triggered based on a condition based on measurement (e.g. predicted measurement threshold), a condition based on time (e.g. time to event is within a threshold value), and/or a condition based on probability (e.g. probability is above a threshold). The event trigger may be based on one or more (e.g., any) combinations of these conditions.

In examples, events may compare predicted and real measurements, and/or may take time and/or probability as an input and/or as an output. Examples of event definitions include one or more of the following. Event P1 may be a predicted measurement of cell x>current measurement of cell x+threshold. Event P2 may be a predicted measurement of cell x<current measurement of cell x−threshold. Event P3 may be a predicted measurement of cell x>current measurement of cell Y+threshold. Event P4 may be a predicted measurement of cell x<current measurement of cell Y−threshold. Event P5 may be a predicted measurement of cell x>predicted measurement of cell Y+threshold. Event P6 may be a predicted measurement of cell x<predicted measurement of cell Y−threshold. Event P7 may be a predicted measurement of cell x>threshold 1, and/or predicted measurement of cell Y<threshold 2.

Conditional handover (CHO) and/or conditional PSCell addition/change (CPA/CPC) (e.g., collectively referred to as CPAC) may be an aim to reduce the likelihood of radio link failure and/or handover failures (HOF).

Handover (e.g., legacy LTE/NR handover) may be triggered by measurement reports, even though there may be nothing preventing the network from sending a HO command to the WTRU even without receiving a measurement report. For example, the WTRU may be configured with an A3 event that triggers a measurement report to be sent when the radio signal level/quality (reference signal received power (RSRP), reference signal received quality (RSRQ), etc) of a neighbor cell becomes stronger (e.g., better) than the Primary serving cell (PCell) and/or (e.g., also) the Primary Secondary serving Cell (PSCell) (e.g., in the case of Dual Connectivity (DC)). The WTRU may monitor the serving and/or neighbor cell(s) and/or may send a measurement report when the condition(s) get fulfilled. When such a report is received, for example, the network (e.g., current serving node/cell) may prepare the HO command (e.g., an RRC Reconfiguration message, with a reconfigurationWithSync) and/or may send the HO command to the WTRU. The WTRU may execute the HO command (e.g., immediately), which may result in the WTRU connecting to the target cell.

CHO may differ from (e.g., legacy) handover in one or more (e.g., two) main aspects. For example, one or more (e.g., multiple) handover targets may be prepared (e.g., as compared to only one target in legacy case). For example, a WTRU may not (e.g., immediately) execute the CHO as in the case of (e.g., legacy) handover. Instead, the WTRU may be configured with triggering condition(s) that include a set of radio conditions, and/or the WTRU may execute the handover towards one of the targets (e.g., only) when/if the triggering condition(s) are fulfilled. For example, in (e.g., legacy) handover, when the WTRU receives a HO command, the WTRU may execute it (e.g., immediately). In CHO, for example, the WTRU may be configured with event(s) and/or condition(s) that may be fulfilled before executing the CHO (e.g., wait until target cell has become stronger than the serving cell by more than a certain threshold).

The CHO command could be sent when the radio conditions towards the current serving cells are (e.g., still) strong and/or may reduce the two main points of failure in (e.g., legacy) handover (e.g., the risk of failing to send the measurement report (e.g. if the link quality to the current serving cell falls below acceptable levels when the measurement reports are triggered in normal handover) and/or the failure to receive the handover command (e.g. if the link quality to the current serving cell falls below acceptable levels after the UE has sent the measurement report, but before it has received the HO command).

The triggering condition(s) for a CHO may be based on the radio quality of the serving cells and/or neighbor cells (e.g., like the conditions that are used in legacy NR/LTE) to trigger measurement reports. For example, the WTRU could be configured with a CHO that has an A3 like triggering conditions and/or associated HO command. The WTRU may monitor the current and/or serving cells. When the A3 triggering conditions are fulfilled, for example, the WTRU may, instead of sending a measurement report, execute the associated HO command and/or may switch its connection towards the target cell.

CHO may help to prevent unnecessary re-establishments in case of a radio link failure. For example, the WTRU may be configured with one or more (e.g., multiple) CHO targets and the WTRU may experience a RLF before the triggering conditions with one or more (e.g., any) of the targets gets fulfilled. Operation (e.g., legacy operation) may result in a RRC re-establishment procedure that may have incurred (e.g., considerable) interruption time for the bearers of the WTRU. In the case of CHO, if the WTRU, after detecting an RLF, selects a cell for which it has a CHO configuration associated with (e.g., the target cell may already be prepared for it), the WTRU may execute the HO command associated with this target cell directly (e.g., instead of continuing with the full re-establishment procedure).

CPC and/or CPA may be extensions of CHO (e.g., in DC scenarios). A WTRU could be configured with triggering conditions for PSCell change and/or addition. When the triggering condition(s) are fulfilled, for example, the WTRU may execute the associated PSCell change and/or PSCell add commands.

Predicted events may be associated with conditional reconfigurations, in a similar way as measurement events based on real measurements. If a predicted event (and/or an event based on both prediction and real measurement) occurs, a conditional reconfiguration may be triggered (e.g., immediately, and/or at the time the predicted event may be expected to occur (potentially after verification using real measurements)).

Based on a condition related to the real measurement, real measurement event, predicted measurement, and/or predicted measurement event (and/or any combination of these), the WTRU may be configured to perform a specific action. Based on what the condition is, and/or whether or not the condition(s) was met, the action may be one or more of the following. A WTRU may cancel triggering of the first (e.g., real) conditional reconfiguration and/or reporting the first measurement report (e.g. if a preferable second/predicted event has been triggered). A WTRU may suspend and/or delay triggering of the first (e.g., real) conditional reconfiguration, pending other (e.g., further) condition(s) to be met (e.g., if a second/predicted event has been triggered, suspend the first/real event until the second event has been verified by real measurements). A WTRU may trigger the first (e.g., real) conditional reconfiguration. For example, the WTRU may include an indication and/or report to the first and/or a second cell that the second (e.g., predicted) event has been triggered (e.g., if an additional condition has not been met). A WTRU may modify the trigger condition of the first (and/or second) event(s) based on the outcome of the second (or first) event. The WTRU may modify the criteria associated with the first and/or second measurement event. For example, if the second (e.g., predicted) event is triggered, the threshold for triggering the first (e.g., real) event may be updated to a higher level, and/or may the first event less likely to occur (e.g. it may still occur if radio conditions are preferable). The WTRU may update the configuration information based on one or more of the measurements and/or predicted measurements. For example, if the first (e.g., real) event is triggered, then the probability threshold for triggering the second (e.g., predicted) event may be increased such that the first event may trigger a reconfiguration unless the second event meets a high probability threshold.

A WTRU may perform one or more of the following actions. A WTRU may be reconfigured and/or perform an action based on real measurements. A WTRU may be reconfigured and/or perform an action based on predicted measurements (e.g., if the action is not taken based on real measurements). A WTRU may be configured to perform an action based on predicted measurements (e.g., if the action is taken based on real measurements). For example, the WTRU may decide not to execute a CHO towards cell A, even though the conditions for that CHO are fulfilled now, if the WTRU has predicted that a CHO towards cell B will be fulfilled in the future. The WTRU may be configured to wait until the future time where the CHO towards cell B get fulfilled before executing the CHO towards cell B. Additionally or alternatively, the WTRU may be configured to execute a CHO towards cell A, upon determining the conditions for that CHO are fulfilled now, (e.g., only) if the WTRU has predicted the condition(s) for a CHO towards cell B will not be fulfilled in the future. Additionally or alternatively, the WTRU may be configured to execute a CHO towards cell A, upon determining the condition(s) for that CHO are fulfilled now, (e.g., only) if the WTRU has predicted that the condition(s) for a CHO towards cell A will (e.g., still) be fulfilled at a future time. A WTRU may be configured with a single event and/or associated action, where the event may be based on condition(s) that consider real and/or predicted measurement signal levels, as described herein.

A WTRU may execute the action(s) associated with a first measurement event when the first measurement event criteria and/or conditions are fulfilled (e.g., only) if the conditions of a second measurement event are also fulfilled (e.g., even though the current measurements are fulfilling conditions, the second measurement event conditions are also fulfilled in the future before executing the action(s). A WTRU may execute the actions associated with the first measurement event when the criteria and/or conditions associated with the first measurement event are fulfilled and when the criteria and/or conditions associated with the second measurement event are not fulfilled. For example, the first measurement event action may be to trigger a conditional HO towards a first cell. If the conditions associated with the second measurement event is to determine whether a second cell will be stronger than the first cell (e.g., in the near future), the WTRU may execute the CHO towards the first cell (e.g., only) if no other cell is stronger for the WTRU (e.g., in the near future). A WTRU may execute the action(s) associated with the second measurement event when the first and second measurement event criteria and/or conditions are fulfilled. For example, the execution of the action(s) associated with the second measurement event may be configured to happen (e.g., immediately, before the event is actually fulfilled), and/or the WTRU may wait until the time has come to execute it. For example, if the prediction window is 500 ms, the WTRU may wait 500 ms, check the conditions are actually fulfilled, and/or may execute the action(s). A WTRU may execute the action(s) associated with the second measurement event when the criteria and/or conditions associated with the first measurement event are not fulfilled and the conditions associated with the second measurement event are fulfilled. A WTRU may be configured to determine when to execute the action(s), as described herein.

A WTRU may execute a third action. For example, the WTRU may execute the third action(s) when the first and the second measurement events are fulfilled. For example, the WTRU may execute the third action(s) when neither the first nor second measurement events are fulfilled. A WTRU may receive configuration information that includes a first measurement event, a second measurement event, a first action associated with the first measurement event, a second action associated with second measurement, criteria associated with the first measurement event, criteria associated with the second measurement event, and/or criteria associated with a third action. The WTR may perform measurements and/or measurement predictions based on one or more reference signals. The WTRU may determine whether the first measurement event is fulfilled based on the measurements and/or the criteria associated with the first measurement event. The WTRU may determine whether the second measurement event is fulfilled based on the predicted measurements and/or the criteria associated with the second measurement event. The WTRU select the first action, the second action, or the third action, based on the determination of whether the first measurement is fulfilled, a determination of whether the second measurement is fulfilled, and a determination of whether the third criteria is fulfilled.

Conditions for selecting one and/or another event (e.g., as described herein), and/or for selecting an action can be one or more of the following. A condition to select an event may include a time to second reconfiguration execution is less than a threshold. A condition to select an event may include a first or a second reconfiguration is higher priority. A condition to select an event may include a priority value. A condition to select an event may include a reconfiguration type (e.g., LTM vs. L3, CHO vs. measurement report, RACH-less configured or not). A condition to select an event may include a target type (e.g., inter-CU, intra-CU, FR1, FR2, intra/inter-frequency and/or RAT). A condition to select an event may include a time of stay in the first target is below a threshold. A condition to select an event may include whether a WTRU has a valid TA for one or the other (e.g., supporting LTM based RACH-less CHO). A condition to select an event may include RLF probability of one target vs. another (or threshold for one of the targets). A condition to select an event may include a probability of success for a second reconfiguration is high (e.g., above a threshold). A condition to select an event may include a pending data amount (e.g., L2 buffer size, application layer information). A condition to select an event may include one or more configured parameters at a potential target cell (e.g., TA available, whether a configured grant is available). A condition to select an event may include a prediction reliability (e.g., above a threshold). A condition to select an event may include a comparison of predicted and real measurements (e.g., predicted future results>real results).

Embodiments described herein may include an interaction between independent real and predicted measurement events.

A WTRU may prioritize a future predicted event over a current real triggered event if certain condition(s) are met. For example, if a first (e.g., real) measurement event is triggered for a first conditional reconfiguration, while a second (e.g., predicted) measurement event has been triggered (and/or reconfiguration pending) for a second conditional reconfiguration, and/or if a configured criteria is met, the WTRU may defer the first conditional reconfiguration and/or may wait for and/or execute the second conditional reconfiguration.

A WTRU may receive, from a first cell, configuration information. The configuration information may include one or more of a first measurement event based on real measurement(s), criteria to trigger a first measurement event, a second measurement event based on predicted measurement(s), criteria to trigger a second measurement event, a configuration of an action to take when both the first and second event are triggered, and/or a condition to determine whether to take the configured action. For example, the configuration information may include a first measurement event, a second measurement event, a first action associated with the first measurement event, a second action associated with the second measurement event, criteria associated with the first measurement event, criteria associated with the second measurement event, and/or a condition (e.g., associated with the action). An action may include one or more of: suspend and/or delay and/or cancel triggering of the first (e.g., real) conditional reconfiguration and/or reporting of the first measurement report. An action may include triggering the first (e.g., real) conditional reconfiguration and/or including an indication and/or report to the first and/or second cell that the second (e.g., predicted) event has been triggered. A condition may include one or more of the following. A condition may include time to second reconfiguration execution is less than a threshold. A condition may include second reconfiguration is higher priority. A condition may include a priority value. A condition may include a reconfiguration type (e.g., LTM, L3). A condition may include a target type (e.g., inter-CU, intra-CU). A condition may include a time of stay in the first target is below a threshold. A condition may include whether the WTRU has a valid timing advance (TA) for one or the other (e.g., supporting LTM based random access channel (RACH)-less CHO). A condition may include radio link failure (RLF) probability of one target vs. another (e.g., and/or threshold for one of the targets). A condition may include a probability of success for a second reconfiguration is high (e.g., above a threshold). A condition may include pending at a amount and/or buffer size. A condition may include one or more configured parameters at a potential target cell (e.g., TA, whether a configured grant is available). A condition may include a prediction reliability (e.g., above a threshold). A condition may include a comparison of predicted and real measurement(s) (e.g., predicted future results greater than real results).

A WTRU may perform real measurements on received reference signals. For example, the WTRU may determine measurements based on one or more reference signals.

A WTRU may determine predicted measurements and/or predicted measurement event triggers based on the real measurements. For example, a WTRU may predict measurements based on the measurements that are determined based on the one or more reference signals. A WTRU may determine that a second measurement event is triggered based on the configured criteria to trigger the second measurement event and/or the real and/or predicted measurements. The WTRU may determine whether a second measurement event is fulfilled based on i) the criteria associated with the second measurement event and ii) the measurements and/or predicted measurements that are based on the measurements. For example, a cell 3 measurement may be above a threshold at time X in the future.

A WTRU may determine that a first measurement event is triggered, for example, based on the configured criteria to trigger the first measurement event and/or real measurement(s). For example, a cell 2 measurement may be above a threshold. The WTRU may determine whether the first measurement event is fulfilled based on the measurements and/or the criteria associated with the first measurement event.

A WTRU may determine to perform the configured action based on the triggered first and/or second measurement events and/or the one or more configured condition(s).

A WTRU may select the first action or the second action based on the condition, a determination of whether the first measurement event is fulfilled, and a determination of whether the second measurement event is fulfilled.

A WTRU may perform the selected action. For example, a WTRU may determine that the WTRU has a TA that may be valid in the third cell at the predicted event time (e.g., as described herein). The WTRU may cancel performing reconfiguration to the second cell (e.g., as described herein). The selected action may include one or more of: sending a measurement report, performing an early synchronization process, and/or performing a handover process.

A WTRU may transmit one or more of the following. A WTRU may transmit a measurement report to the first cell, including an indication of the events which have been triggered, and/or the action and/or prioritization determined. A WTRU may transmit a reconfiguration complete (e.g., handover complete) message and/or indication to the determined target cell upon reconfiguration (e.g., the second and/or the third cell), based on the action and/or interaction between event(s) including an indication of the events which have been triggered, and/or the action and/or prioritization determined.

One or more examples described herein may include and/or use direct event prediction (e.g., direct prediction of whether an event will occur), and/or indirect event prediction (e.g., prediction of measurement value(s), and/or determining whether the event criteria will be met based on the measurement values(s)).

Embodiments described herein may include other (e.g., new) measurement events that compare current (e.g., real) conditions and predicted conditions.

Other (e.g., new) events that compare the outcome of predicted and real measurements and/or may trigger the event(s) based on the comparison may be described herein. For example, the first measurement event (e.g., and/or report and/or conditional reconfiguration) can be triggered if predicted measurement of cell x<current measurement of cell Y.

Additionally or alternatively (e.g., to separate events for real and/or predicted, and/or defining the interaction condition), other (e.g., new) events which (e.g., only) trigger when a condition related to real measurements and a condition related to predicted measurements are met. For example, an event may be based on predicted and current measurements (e.g., event X may be associated with one action, action triggered where serving cell current signal level<threshold1, and neighbor cell y is expected to be stronger than the serving cell by more than a threshold2 in the future, etc.). For example, predicted measurement of cell 3 at time X>current measurement of cell 2, may have a similar outcome as described herein, because the prediction of cell 3 may prevent the event from triggering to reconfigure to cell 2. This may be (e.g., mainly) for indirect prediction.

A WTRU may receive, from a first cell, a configuration of a measurement event based on the comparison of a metric determined from real measurement(s) with a metric determined from predicted measurement(s) (e.g., predicted using an AIML model), an action based on meeting a condition of the measurement event. A measurement event may be associated with a reporting configuration. A measurement event may be associated with a conditional reconfiguration.

An event may include one or more of the following. Event P1 may include a predicted measurement of cell x>current measurement of cell x+threshold. Event P2 may include a predicted measurement of cell x<current measurement of cell x−threshold. Event P3 may include a predicted measurement of cell x>current measurement of cell Y+threshold. Event P4 may include a predicted measurement of cell x<current measurement of cell Y−threshold. Event P5 may include a predicted measurement of cell x>predicted measurement of cell Y+threshold. Event P6 may include a predicted measurement of cell x<predicted measurement of cell Y−threshold. Event P7 may include a predicted measurement of cell x>threshold 1, predicted measurement of cell Y<threshold 2>.

A WTRU may determine a real measurement, for example, based on received RS and/or the configured measurement event. For example, the WTRU may determine a real measurement based on a cell quality measurement (e.g., RSRP).

A WTRU may determine a predicted measurement, for example, based on the configured measurement event, the determined real measurement, and/or the model in use. For example, the WTRU may determine a predicted measurement based on a cell quality prediction (e.g., RSRP at X time in the future).

A WTRU may determine if the condition of the measurement event is met, for example, based on the real measurement and/or predicted measurement. If the condition is met, the WTRU may trigger the configured action. For example, the WTRU may transmit a measurement report. For example, the WTRU may trigger a reconfiguration (CHO).

Embodiments described herein may include a combination of independent events using at least one event based on direct prediction of event trigger and/or a condition based on indirect prediction and/or measurements. One or more (e.g., any) of the embodiments described herein may use (e.g., both) direct and/or indirect predictions and/or may combine embodiments. For example, an embodiment may include direct event prediction, compare the triggered events (e.g., a real event, and/or a directly predicted event), and/or may utilize indirect prediction for the configured condition (e.g., based on the new event listed herein). If the direct predicted event is triggered, and/or the indirect condition is met, the WTRU may perform the configured action(s). In examples, the WTRU may predict that the second event is triggered based on a direct prediction. The WTRU may determine the first event is triggered based on real measurement(s). The WTRU may compare the predicted measurement(s) with the real measurement(s). If the predicted measurement(s) of cell x>predicted measurement(s) of cell Y, the WTRU may execute the second event; otherwise the WTRU may execute the first event.

1. A wireless transmit/receive unit (WTRU) comprising:
a processor configured to:
receive configuration information, the configuration information comprising a first measurement event, a second measurement event, a first action associated with the first measurement event, a second action associated with the second measurement event, criteria associated with the first measurement event, criteria associated with the second measurement event, and a condition;
determine measurements based on one or more reference signals;
predict measurements based on the measurements that are determined based on the one or more reference signals;
determine whether the first measurement event is fulfilled based on the measurements and the criteria associated with the first measurement event;
determine whether the second measurement event is fulfilled based on i) the criteria associated with the second measurement event and ii) predicted measurements that are based on the measurements;
select the first action or the second action based on the condition, a determination of whether the first measurement event is fulfilled, and a determination of whether the second measurement event is fulfilled; and
perform the selected action.

2. The WTRU of claim 1, wherein the processor being configured to perform the action comprises the processor being configured to suspend, delay, or cancel triggering of a first conditional reconfiguration or reporting of a first measurement report.

3. The WTRU of claim 1, wherein the processor being configured to perform the action comprises the processor being configured to trigger the first conditional reconfiguration and send an indication to a first cell or a second cell, wherein the indication indicates that the second measurement event has been triggered.

4. The WTRU of claim 1, wherein the processor being configured to perform the action comprises the processor being configured to modify the criteria associated with the first or second measurement event.

5. The WTRU of claim 1, wherein the condition associated with the action comprises one or more of a time to second reconfiguration execution is less than a threshold, a second reconfiguration is higher priority, a priority value, a reconfiguration type, a target type, a time of stay in a first target is below a threshold, whether the WTRU has a valid timing advance (TA) for one or the other, radio link failure probability of one or more targets, probability of success for a second reconfiguration is high, a pending data amount, a buffer size, one or more configured parameters at a potential target cell, prediction reliability, or a comparison of the first set of measurements and the one or more predicted measurements.

6. The WTRU of claim 1, wherein the processor is configured to send a measurement report to a first cell, wherein the measurement report comprises an indication of the determined action or prioritization.

7. The WTRU of claim 1, wherein the processor is configured to update the configuration information based on one or more of the measurements or the predicted measurements.

8. The WTRU of claim 1, wherein the processor is configured to use an artificial intelligence (AI) or machine learning (ML) model to determine the predicted measurements.

9. The WTRU of claim 1, wherein the processor being configured to perform the selected action comprises the processor being configured to:
send a measurement report,
perform an early synchronization process, or
perform a handover process.

10. A method performed by a wireless transmit/receive unit (WTRU), the method comprising:
receiving configuration information, the configuration information comprising a first measurement event, a second measurement event, a first action associated with the first measurement event, a second action associated with the second measurement event, criteria associated with the first measurement event, criteria associated with the second measurement event, and a condition;
determining measurements based on one or more reference signals;
predicting measurements based on the measurements that are determined based on the one or more reference signals;
determining whether the first measurement event is fulfilled based on the measurements and the criteria associated with the first measurement event;
determining whether the second measurement event is fulfilled based on i) the criteria associated with the second measurement event and ii) the measurements or predicted measurements that are based on the measurements;
selecting the first action or the second action based on the condition, a determination of whether the first measurement event is fulfilled, and a determination of whether the second measurement event is fulfilled; and
performing the selected action.

11. The method of claim 10, wherein performing the action comprises suspending, delaying, or canceling triggering of a first conditional reconfiguration or reporting of a first measurement report.

12. The method of claim 10, wherein performing the action comprises triggering the first conditional reconfiguration and send an indication to a first cell or a second cell, wherein the indication indicates that the second measurement event has been triggered.

13. The method of claim 10, wherein performing the action comprises modifying the criteria associated with the first or second measurement event.

14. The method of claim 10, wherein the condition associated with the action comprises one or more of a time to second reconfiguration execution is less than a threshold, a second reconfiguration is higher priority, a priority value, a reconfiguration type, a target type, a time of stay in a first target is below a threshold, whether the WTRU has a valid timing advance (TA) for one or the other, radio link failure probability of one or more targets, probability of success for a second reconfiguration is high, a pending data amount, a buffer size, one or more configured parameters at a potential target cell, prediction reliability, or a comparison of the first set of measurements and the one or more predicted measurements.

15. The method of claim 10, further comprising sending a measurement report to a first cell, wherein the measurement report comprises an indication of the determined action or prioritization.

16. The method of claim 10, further comprising updating the configuration information based on one or more of the measurements or the predicted measurements.

17. The method of claim 10, wherein the predicted measurements are determined based on an artificial intelligence (AI) or machine learning (ML) model.

18. The method of claim 10, wherein performing the selected action comprises:
sending a measurement report,
performing an early synchronization process, or
performing a handover process.
